(19) United States
(12) Patent Application Publication
(10) Pub. No.: US 2024/0330153 A1
(43) Pub. Date: Oct. 3, 2024

(54) METHOD FOR MONITORING THE EXECUTION OF AN APPLICATION SOFTWARE IMPLEMENTING A SAFETY FUNCTION

(71) Applicant: STMICROELECTRONICS INTERNATIONAL N.V., Geneva (CH)

(72) Inventor: Alessandro BASTONI, Aix en provence (FR)

(21) Appl. No.: 18/602,977

(22) Filed: Mar. 12, 2024

(30) Foreign Application Priority Data
Mar. 27, 2023 (FR) 2302889

(51) Int. Cl. G06F 11/36

(52) U.S. Cl. CPC G06F 11/3636

(57) ABSTRACT

Method for monitoring the execution of an application software implementing a safety function, comprising implementing a software-based lock step on a dual asymmetrical processing units structure, the processing units structure including a first processing unit and a second processing unit having, due to the asymmetry, a different hardware structure and/or lower computations capability with respect to the first processing unit. A first runtime software is executed on the first processor while a second runtime software being a potentially modified version of the first runtime software and having the same behavior as that of the first runtime software, is executed on the second processor.

### CROSS REFERENCE TO RELATED APPLICATIONS

This application claims the priority benefit of French patent application number FR2302889, filed on Mar. 27, 2023, entitled “PROCEDE DE SURVEILLANCE DE L'EXECUTION D'UN LOGICIEL D'APPLICATION METTANT EN OEUVRE UNE FONCTION DE SECURITE”, which is hereby incorporated by reference to the maximum extent allowable by law.

### TECHNICAL FIELD

Embodiments of the disclosure relate to a software lock step scheme for monitoring the execution of an end user application software implementing a safety function, more particularly based on asymmetrical System on Chip (SoC).

### BACKGROUND

In functional-safety compliant applications based on asymmetrical SoC, it is needed to manage permanent and transient failures affecting dual asymmetrical computer processing units (CPUs).

A first solution is an hardware solution which however requires that the SoC has been designed with hardware-built lock step schemes.

But if the SoC has not been explicitly designed for safety applications with hardware-built lock step schemes, the solution must be implemented by software means.

As the solution is tightly coupled to end user application software, no standard software solution can be technically provided.

There is thus a need to provide a software architecture enabling end customers to implement software-based lock step solutions on SoC with dual asymmetrical CPUs which were not developed with hardware-built lock step schemes.

### BRIEF SUMMARY

According to an embodiment it is proposed way to build an efficient and optimized software-based lock step with minimal modification to the original end user application software.

According to an embodiment a software architecture is proposed to outpace existing software lock step basic schemes (based on cross-exchange) in optimization and flexibility on the assumed class of target SoCs, as it strongly leverages on the CPU asymmetrical characteristic.

According to an aspect a method is proposed for monitoring the execution of an application software (the end user application software) implementing a safety function.

The method according to this aspect comprises implementing a software-based lock step on a dual asymmetrical processing units structure, said processing units structure including a first processing unit and a second processing unit having, due to said asymmetry, a different hardware structure and/or lower computations capability with respect to said first processing unit, said method comprising
partitioning the application software into a startup software and a first runtime software executing sequentially and iteratively said safety function on the basis of a state machine during a sequence of successive time intervals,
providing a second runtime software being a potentially modified version of the first runtime software and having the same behavior (i.e. for example implementing the same relationship between input data and output data) as that of said first runtime software,
making run the startup software and the first runtime software by the first processing unit and making run the second runtime software by the second processing unit, and during a current time interval of said sequence:
performing a checking processing comprising at least a comparison processing performed at the end of the execution of said second runtime software between results of the execution of the first runtime software and results of the execution of the second runtime software.

Thus, the combination of a dual asymmetrical CPUs structure with the use of two runtime software, one of which being potentially less efficient, permits to obtain an asymmetrical loosely coupled lock step by software with a reduced complexity of the end user software application modifications while satisfying requirements included in specific safety standards like IEC 61508, ISO 26262 for multi-CPU SoC.

The two runtime software may thus be software embedded on such a SoC included in for example but in a nonlimitative way, a dust vacuum robot.

According to an embodiment, the first runtime software receives at a current iteration a first current input data vector and a first current state variables vector and delivers a first current output data vector and a first current updated state variable vector which will be respectively the next input data vector and the next state variables vector for the next iteration.

In other words, the first runtime software is modeled to be an atomic state machine which for each given iteration, receives a first current input data vector and a first current state variables vector and delivers a first current output data vector and a first current updated state variable vector which will be respectively the next input data vector and the next state variables vector for the next iteration.

According to this embodiment the checking processing comprises:
a) selecting at least one iteration and for said at least one selected iteration:
b) storing the corresponding first output data vector and the corresponding first updated state variable vector in a memory,
c) providing the second runtime software with the corresponding first input data vector and the corresponding first state variables vector, and obtaining from said second runtime software, at a moment later than the moment when the corresponding first output data vector and the corresponding first updated state variable vector are delivered, a corresponding second output data vector and a corresponding second updated state variable vector,
d) comparing said corresponding first output data vector with said corresponding second output data vector and comparing said corresponding first updated state variable vector with said corresponding second updated state variables vector, and
e) in case of match at step d), repeating said checking processing for the next time interval of said sequence.

Such an embodiment permits to detect, in case of mismatch at step d), permanent failures affecting the first processing unit and/or the second processing unit.

Other embodiments permit to add the capability to detect transient failures affecting the first processing unit.

More particularly, according to an embodiment, said checking processing may further comprise:
f) performing during said current time interval of said sequence, a double execution of each first runtime software iteration using the same corresponding input data vector and the same corresponding state variables vector for both executions, and comparing both output data vectors and comparing both updated state variables vectors respectively obtained by both executions, and
g) in case of match at step f) for each double execution of each iteration, repeating said checking processing for the next time interval of said sequence.

Such an embodiment permits to detect, in case of mismatch at step f), transient failures affecting the first processing unit.

This double computation runtime software is an option which, when implemented, leads to a higher time performance penalty.

In particular when this double computation option is enabled, wherein said checking processing further comprises, during said current time interval:
h) counting the number of iterations of the first runtime software executed during execution of the second runtime software,
i) comparing at the end of the execution of the second runtime software, the counting value with an expected value, and
j) in case of match at step i) repeating said checking processing for the next time interval of said sequence.

In other words, in such a case the checking may comprises only verifying that the first runtime software has been executed the expected number of times (which is deterministically known) during execution of the second runtime software.

For performing such a minimal level of check, a simple unique counter is enough.

According to another embodiment which in particular permits to detect transient failures affecting the first processing unit, for example used when the double computation option is not enabled, said checking processing may further comprise, during said current time interval:
k) storing for each iteration of the first runtime software, the corresponding first current input data vector, the corresponding first current state variables vector, the corresponding first current output data vector and the corresponding first current updated state variable vector,
l) performing at the end of the execution of the second runtime software, plausibility checks on all vectors stored in step k),
m) in case of successful checks at step l) repeating said checking processing for the next time interval of said sequence.

The plausibility checks may further comprise for example boundary values violation checks.

Of course, the efficiency and the complexity of checks implementation strongly depend on the nature of the algorithm implemented in the first runtime software and on related dependencies between inputs and outputs.

The man skilled in the art will be able to choose the appropriate plausibility checks depending on the end user safety application.

Such an embodiment permits to detect, in case of unsuccessful checks at step l), transient failures affecting the first processing unit.

Whatever the embodiment, said checking processing may further comprise in case of mismatch at step d) and/or f) and/or i) and/or in case of unsuccessful checks at step l), delivering an error signal.

Then end user may thus decide which action is to be taken upon receipt of such an error signal.

For example, when the end user wants to implement a fail-operational or fail-tolerant scheme, the method may further comprise repeating said checking processing for the next time interval of said sequence, despite the delivery of said error signal.

According to another aspect, a system on chip is proposed, comprising a dual asymmetrical processing units structure, said processing units structure including a first processing unit and a second processing unit having, due to said asymmetry, a modified hardware structure and/or lower computations capability with respect to said first processing unit, said processing unit structure being configured to perform the method for monitoring the execution of an application software implementing a safety function.

### BRIEF DESCRIPTION OF DRAWINGS

Other features and advantages of the present invention will appear when examining the following detailed description, only providing non-limiting example of embodiments, with reference to the annexed drawings in which:

FIG. 1, FIG. 2, FIG. 3, FIG. 4, FIG. 5, FIG. 6, FIG. 7, FIG. 8 and FIG. 9 illustrate embodiments of the invention.

### DETAILED DESCRIPTION

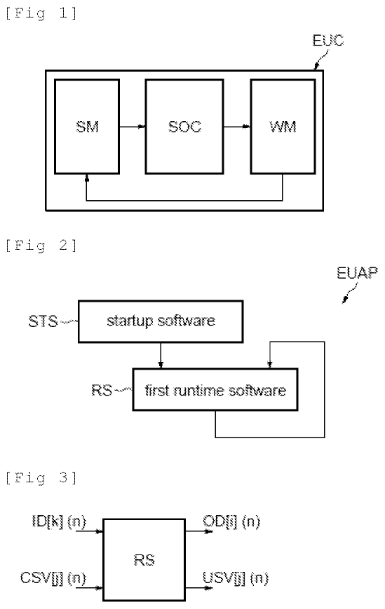

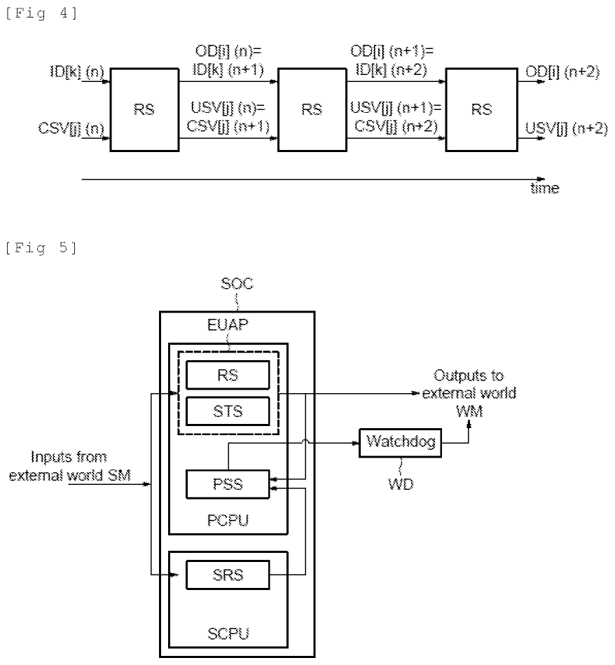

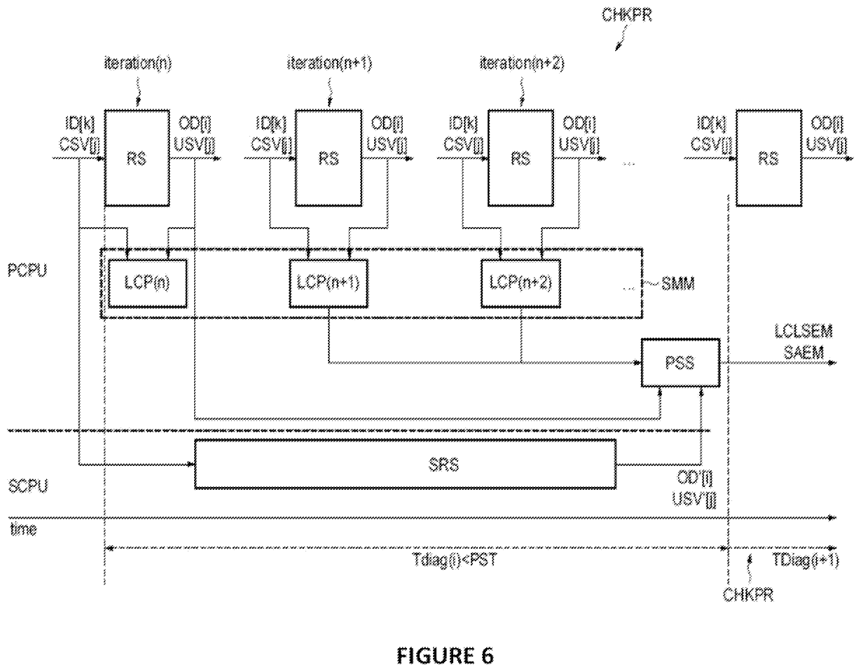

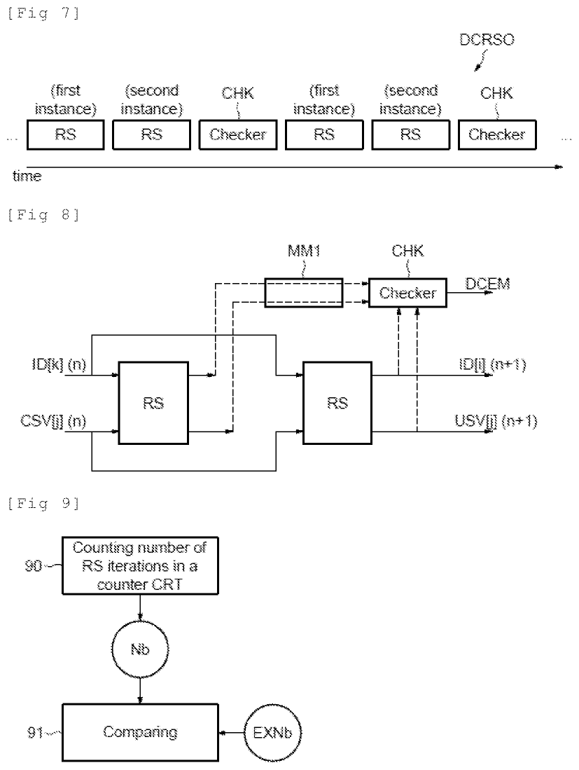

In FIG. 1, reference sign EUC designates a device or equipment under control, for example a dust vacuum robot, including for example conventional sensors SM, conventional motors WM controlling the movements of the robot wheels and a system on chip SoC configured to execute an embedded application software implementing a safety function.

The system on chip is configured to receive input data from the sensors and deliver commands to the motors WM.

The safety function depends on the application.

For example for such a robot, the safety function may include in a non limitative way, the following actions: “do not hit an object”, “do not go down stairs”, “do not exceed a chosen speed” . . . .

As illustrated in FIG. 2, the application software EUAP implementing the safety function on the SoC is partitioned in two subparts: a startup software STS and a first runtime software RS.

The startup software STS is a section of the application software EUAP executed only at the system startup/reset or during special maintenance/offline periods. It is in charge to execute startup basic system diagnostics and to correctly configure the SoC for the implementation of the safety function.

The first runtime software RS is a section of the application software EUAP continuously executed to implement the safety function.

More precisely, the first runtime software executes sequentially and iteratively said safety function on the basis of a state machine during a sequence of successive time intervals.

As illustrated in FIGS. 3 and 4, the first runtime software includes the atomic state machine which for each current execution iteration, receives as input a first current input vectors of data ID[k] (first input data vector) and a first current state variables vector CSV[j] and produces a first current output data vector OD[i] (Output Data vector) and a first current updated state variables vector USV[j] which will be respectively the next input data vector and the next state variables vector for the next iteration of the first runtime software.

In case signal(s) coming/going from/to peripherals are used for input or outputs, the data vectors ID[k] and/or OD[j] contain a digital copy of signal(s) value(s) as “model” of the signals itself.

The first current input vectors of data ID[k] is a collection of any input data needed from the outside (the sensors SM) by the first runtime software RS, and additional data coming from previous iteration execution of the first runtime software RS (temporary data). Data can be of any nature and produced by the system in any way (for example, stored in a volatile memory by a Direct Memory Access (DMA) module, directly received by a communication peripheral).

For example, in case of a dust vacuum robot the input data may be for example data related to the trajectory, data related to the current speeds of the wheels, data related to the direction, . . . .

The first current output data vector OD[i] is a collection data generated by the first runtime software RS to implement the safety function by interacting with the outside world, and temporary data to be used in the next iteration execution of the first runtime software RS. Data can be of any nature and used to interact with the outside in different ways, for example properly setting for General Purpose Input/Output (GPIO) lines, or sent with a communication peripheral to a remote peer, or to modify generated signals like Pulse Width Modulated (PWM) signals or analog lines.

The first current state variables vector CSV[j] is a collection of all the first runtime software internal variables able to determine in unique way the complete status of its state machine.

For example in case of a dust vacuum robot, these variables may be in a non-limitative way, variables related to the following different states: “cleaning”, “return to base station”, “in charge” . . . .

The first current updated state variables vector USV[j] has the same structure of CSV[j], the only difference is that USV[j] is updated by the execution of each iteration of the first runtime software (in other words it reflects the state machine status after the execution of an iteration execution of the first runtime software.

As illustrated in FIG. 5, the system on chip SoC includes a first or principal processing unit PCPU, for example a processor, and a second or secondary processing unit SCPU, for example a processor.

Both processing units PCPU and SCPU form a dual asymmetrical processing units structure.

The first processing unit PCPU is charged to execute the application software. It can be supported in the implementation of the safety function by specific hardware accelerators used at runtime by the first runtime software RS.

The second processing unit SCPU has, due to said asymmetry, a different hardware structure and/or lower computations capability with respect to said first processing unit PCPU.

For example, as per the asymmetric nature of the processing units structure, the second processing unit is not equipped with the full set of hardware accelerators available (if the case) on the first processing unit PCPU, or the second processing unit can have lower computations capability (because running at lower clock frequency and/or because being a simpler processing unit (CPI) and/or because using part of its bandwidth to execute other tasks).

The second processing unit is configured to execute a second runtime software.

The second runtime software SRS is a potentially modified version of the first runtime software.

It has the same behavior of the first runtime software RS (i.e for example implementing the same relationship between input data and output data), so to produce the same outputs OD[j], USV[j] when fed with the same inputs ID[k], CSV[j].

Implementation at source code level may be different to cope for example with the lack on the second processing unit of the hardware accelerators used in the first processing unit.

For example, the lack of a Floating Point Unit (FPU) on the second processing unit SCPU can be managed in the second runtime software SRS by a software library implementing Floating Point Unit functions.

By analogy the lack of a Digital Signal Processor (DSP) on the second processing unit SCPU can be managed in the second runtime software SRS by a software library implementing Digital Signal Processor functions.

In case the asymmetrical nature of both processing units PCPU and SCPU is just related to clock frequency/computation power, the second runtime software SRS could be assumed to be mainly identical to the first runtime software RS.

If a software watchdog module is present for other needs than those of the invention, it can be managed by the first processing unit PCPU and in case of timeout expiration it must be able to reset the two processing unit PCPU and SCPU and to force the system to safe state.

However this watchdog module is not mandatory for performing the method according to the invention.

Another software module PSS runs on the first processing unit PCPU. This software module is a dedicated software charged to execute basic safety tasks like copying/retrieving data to/from a safe area, cross-checking data produced by the lock step scheme, error reporting, external watchdog management.

A safe area is a memory area used by the algorithm to store safety related data.

All data stored in this area are advantageously protected against soft errors by a checksum (for example a simple checksum like XOR is enough).

When a data (or set of data) is (are) retrieved from the safe area, its integrity by checking related checksum is verified before consuming it.

We refer now more particularly to FIG. 6 for describing an embodiment of the method according to the invention including a checking processing CHKPR.

As mentioned above, the first runtime software RS execute sequentially and iteratively said safety function on the basis of a state machine during a sequence of successive time intervals Tdiag(i).

Tdiag (i) is also the time period or time interval within which the computation of the second runtime software is executed by the second processing unit SCPU and checks are executed by the software module PSS.

The system timeline is therefore partitioned in a sequence of time intervals Tdiag(i).

The standard IEC 61508 defines a so called «Process Safety Time (PST)» as a “Period of time between a failure, that has the potential to give rise to a hazardous event, occurring in the equipment under control EUC and the time by which action has to be completed in the equipment under control EUC to prevent the hazardous event occurring”.

As per the interpretation from IEC61508 point of view, the PST value is greater than Tdiag value, so Tdiag discriminates the safety applications that potentially can be addressed by the method according to the invention, according to the required PST.

The more complex, or slow, is the first processing unit PCPU “emulation” by the second processing unit SCPU via execution of the second runtime software SRS, the greater Tdiag will be.

In FIG. 6, it is assumed that a double computation runtime software option (which will be explained more in detail thereafter) is not enabled.

Further for simplification reasons of the figure, although, as explained above with reference to FIG. 4, a current iteration (n) of the first runtime software RS receives as input the first current input vectors of data ID[k] (n) and the first current state variables vector CSV[j] (n) and produces the first current output data vector OD[i] (n) and the first current updated state variables vector USV[j] (n) which will be respectively the next input data vector ID[k] (n+1) and the next state variables vector CSV[j] (n+1) for the next iteration (n+1) of the first runtime software, the indexes n, n+1, n+2, . . . of the successive iterations are not represented in this FIG. 6.
1) At the first execution (for example) of the first runtime software RS, which is here for example iteration (n), in the current time interval Tdiag(i), a local copy LCP (n) of ID, OD, CSV, USV is stored in the safe area SMM.

The stored copy of ID/CSV is used as input for the execution of the second runtime software SRS which immediately starts in “background” on the second processing unit SCPU.

The first runtime software RS is sequentially and iteratively executed on the first processing unit PCPU.

For each iteration (n), (n+1), n+2), . . . a local copy LCP (n), LCP (n+1), LCP (n+2), . . . of corresponding ID, OD, CSV, USV is saved in the safe area SMM.

The second runtime software SRS produces its output OD′[i] and USV′[j].

The second processing unit SCPU informs the first processing unit PCPU that data are available.

Then the first processing unit PCPU starts the execution of the module PSS.

Safety checks are performed by this module PSS.

More particularly a first check comprises a comparison between OD′[i] and OD[i] and between USV′[j] and USV[j].

If OD′[i]=OD[i] and USV′[j]=USV[j] (corresponding to a match), there is no detected failure. If there is no match, a permanent failure affecting the first processing unit PCPU is detected.

A second check may be advantageously performed.

More precisely the set of stored local copies LCP(n), LCP(n+1), LCP(n+2) . . . is checked for consistency.

This permits to detect eventual transient failures affecting the first processing unit PCPU during its execution of RS in the time interval Tdiag.

This second check is performed by the module PSS at the end of second software SRS execution, on all available local copies LCP(p).

This second check is for example based on plausibility checks methods, like for example boundary values violation checks.

The efficiency and the complexity of the second check implementation strongly depend on the nature of the algorithm implemented in the first runtime software RS and on related dependencies between inputs and outputs.

In case of match:
the external watchdog (if any) is reset,
the procedure including the checking processing CHKPR restarts from point 1) above for the next time interval Tdiag (i+1).

In case of mismatch:
the result of the diagnostic is “FAIL” and it is reported to the system error collector for needed actions by a dedicated error message LCLSEM,
the external watchdog (if any) is not reset (paving the way for its possible intervention).

As indicated above, when a data (or set of data) is (are) retrieved from the safe area SMM, its integrity by checking related checksum is verified before consuming it.

In case of failed check on the checksum, the result of the whole diagnostic is also “FAIL” and it is reported to the system error collector for needed actions by dedicated error message SAEM.

As a variant, the procedure could be restarted from point 1) above (like in the case of match) if the end user wants to implement a fail-operational or fail-tolerant scheme.

We refer now more particularly to FIGS. 7 and 8 for describing the double computation runtime software option DCRSO.

This option, when enabled in the first runtime software RS, foresees the doubled execution of each current iteration (or instance) (n) of the first runtime software RS, by using the same set of inputs ID[k] (n), CSV[j] (n).

The results of the first execution are stored in a volatile memory MM1 and then compared with the results obtained by the second execution.

This comparison is performed by software checker CHK implemented in the first processing unit PCPU.

A mismatch is reported to the system error collector for needed actions by a dedicated error message DCEM.

This option, when enabled, imposes the highest performance penalty to the method according to the invention (almost 50% performance loss on first runtime software RS execution on the first processing unit PCPU).

When this option is enabled, the second check mentioned above may be simpler.

More precisely, in such a case, as illustrated in FIG. 9, the minimum level of checking is to verify that the first runtime software RS has been executed the expected number of times during SRS execution period (that number of times is deterministically known).

In such a case a simple unique counter CRT is enough.

The number of RS iterations are counted (step 90) and the obtained value Nb is compared (step 91) with the expected value EXNb.

This disclosure proposes thus a reference software architecture enabling end users to implement a software-based lock step solution on SoC with dual asymmetrical CPUs which were not developed with hardware-built lock step schemes.

The implementation allows to comply to functional safety standard requirements (for example IEC61508 for industrial applications) with relevant advantages:
reduced complexity of the modifications of the application software EUAP,
optimized performance loss by leveraging the specific characteristics of the dual asymmetrical CPU schemes.

The proposed software architecture outpaces existing software lock step basic schemes (based on cross-exchange) in optimization and flexibility on the assumed class of target SoCs, as it strongly leverages on the CPU asymmetrical characteristic.

1. A method for monitoring the execution of an application software implementing a safety function comprising implementing a software-based lock step on a dual asymmetrical processing units structure, the the dual asymmetrical processing units structure including a first processing unit and a second processing unit having, due to an asymmetry, a different hardware structure or lower computations capability with respect to the first processing unit, wherein the method comprises:
partitioning the application software into a startup software and a first runtime software executing sequentially and iteratively the safety function on a basis of a state machine during a sequence of successive time intervals;
providing a second runtime software being a potentially modified version of the first runtime software and having the same behavior as that of the first runtime software;
making run the startup software and the first runtime software by the first processing unit and making run the second runtime software by the second processing unit; and
during a current time interval of the sequence, performing a checking processing comprising at least a comparison processing performed at an end of an execution of the second runtime software between first results of an execution of the first runtime software and second results of the execution of the second runtime software.

2. The method of claim 1, wherein the first runtime software receives at a current iteration a first current input data vector and a first current state variables vector and delivers a first current output data vector and a first current updated state variable vector which will be respectively a next input data vector and a next state variables vector for a next iteration, and wherein the checking processing comprises:
a) selecting at least one iteration and for the at least one iteration selected:
b) storing the corresponding first output data vector and the corresponding first updated state variable vector in a memory,
c) providing the second runtime software with a corresponding first current input data vector and a corresponding first current state variables vector, and obtaining from the second runtime software, at a moment later than a moment when the corresponding first output data vector and the corresponding first current updated state variable vector are delivered, a corresponding second output data vector and a corresponding second updated state variable vector,
d) comparing the corresponding first output data vector with the corresponding second output data vector and comparing the corresponding first updated state variable vector with the corresponding second updated state variables vector, and
e) in case of match at step d), repeating the checking processing for a next time interval of the sequence.

3. The method of claim 2, wherein the checking processing further comprises:
f) performing during the current time interval of the sequence, a double execution of each first runtime software iteration using the same corresponding input data vector and the same corresponding state variables vector for both executions, and comparing both output data vectors and comparing both updated state variables vectors respectively obtained by both executions, and
g) in case of match at step f) for each double execution of each first runtime software iteration, repeating the checking processing for the next time interval of the sequence.

4. The method of claim 3, wherein the checking processing further comprises, during the current time interval:
h) counting a number of iterations of the first runtime software executed during execution of the second runtime software,
i) comparing at an end of the execution of the second runtime software, a counting value with an expected value, and
j) in case of match at step i) repeating the checking processing for the next time interval of the sequence.

5. The method of claim 2, wherein the checking processing further comprises, during the current time interval:
k) storing for each iteration of the first runtime software, the corresponding first current input data vector, the corresponding first current state variables vector, the corresponding first current output data vector and the corresponding first current updated state variable vector,
l) performing at the end of the execution of the second runtime software, plausibility checks on all vectors stored in step k),
m) in case of successful checks at step l) repeating the checking processing for the next time interval of the sequence.

6. The method of claim 2, wherein the checking processing further comprises in case of mismatch at step d) and/or f) and/or i) and/or in case of unsuccessful checks at step l), delivering an error signal.

7. The method of claim 6, further comprising repeating the checking processing for the next time interval of the sequence, despite a delivery of the error signal.

8. The method of claim 3, wherein the checking processing further comprises in case of mismatch at step d) and/or f) and/or i) and/or in case of unsuccessful checks at step l), delivering an error signal.

9. The method of claim 8, further comprising repeating the checking processing for the next time interval of the sequence, despite a delivery of the error signal.

10. The method of claim 4, wherein the checking processing further comprises in case of mismatch at step d) and/or f) and/or i) and/or in case of unsuccessful checks at step l), delivering an error signal.

11. The method of claim 10, further comprising repeating the checking processing for the next time interval of the sequence, despite a delivery of the error signal.

12. The method of claim 5, wherein the checking processing further comprises in case of mismatch at step d) and/or f) and/or i) and/or in case of unsuccessful checks at step l), delivering an error signal.

13. The method of claim 12, further comprising repeating the checking processing for the next time interval of the sequence, despite a delivery of the error signal.

14. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 1.

15. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 2.

16. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 3.

17. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 4.

18. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 5.

19. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 6.

20. A system on chip comprising a dual asymmetrical processing units structure, the dual asymmetrical processing units structure including a first processing unit and a second processing unit having, due to an asymmetry, a different hardware structure or lower computations capability with respect to the first processing unit, the dual asymmetrical processing unit structure being configured to perform the method for monitoring the execution of an application software implementing a safety function according to claim 7.
